(19) United States
(12) Patent Application Publication
(10) Pub. No.: US 2012/0320181 A1
(43) Pub. Date: Dec. 20, 2012

(54) APPARATUS AND METHOD FOR SECURITY USING AUTHENTICATION OF FACE

(75) Inventors: Tae-Hwa Hong, Seoul (KR); Hong-II Kim, Seongnam-si (KR); Joo-Young Son, Suwon-si (KR); Sung-Dae Cho, Yongin-si (KR); Yun-Jung Kim, Seoul (KR)

(73) Assignee: Samsung Electronics Co., Ltd., Suwon-si (KR)

(21) Appl. No.: 13/525,991

(22) Filed: Jun. 18, 2012

(30) Foreign Application Priority Data
Jun. 16, 2011 (KR) 10-2011-0058671

(51) Int. Cl. G06K 9/46; H04N 7/18

(52) U.S. Cl. 348/78; 348/77; 348/E07.085

(57) ABSTRACT

An apparatus and a method for security using the face authentication is provided. The apparatus includes a face detector for detecting a facial region in an input image; a face guide region generator for generating a face guide region for authenticating a face in the input image, and displaying the generated face guide region on a screen; an image capturer for capturing the input image when the detected facial region is matched with the face guide region; a facial feature extractor for extracting information regarding features of the face from the captured input image; and a facial feature storage unit for storing the extracted information regarding the features of the face.

### PRIORITY

This application claims priority under 35 U.S.C. §119(a) to a Korean Patent Application filed in the Korean Intellectual Property Office on Jun. 16, 2011 and assigned Serial No. 10-2011-0058671, the entire disclosure of which is incorporated herein by reference.

### BACKGROUND OF THE INVENTION

1. Field of the Invention

The present invention relates generally to a security apparatus, and more particularly, to an apparatus and a method of authentication using the face of a user.

2. Description of the Related Art

Recently, the demand for personal devices has significantly increased due to the increased interest in personalized content such as the activation of application stores, the popularization of a Social Network Service (SNS) and the like due to the spread of personal devices including a smartphone, a tablet Personal Computer (PC) and the like.

Such smart devices are providing various security functions for the security of personalized content as well as the devices themselves. Existing security functions include a Personal Identification Number (PIN) input scheme and a password input scheme, a pattern input scheme and the like. The pattern input scheme is a technology for using a pattern, which has been input through an input device such as a touchscreen of a device, as security authentication. For example, the pattern input scheme is a scheme where a preset number of nodes (e.g. 9 nodes in a 3×3 grid) are arranged on a touchscreen and a cryptograph is set in the order and pattern of touching the arranged nodes.

Also, although an approach utilizing biometric information such as fingerprints or a face has recently become more common, various problems prevent the approach utilizing biometric information from easily exceeding the limit of commercialization.

In a portable device as described above, a particular number (e.g., 4 to 16 digits) of characters or numbers are usually input as a PIN and a password.

However, because such a PIN and a password depend only on the memory of a user, most users use a security code having a small number of digits or security codes, which are often also used for other security purposes.

Accordingly, when a password is input, it is inconvenient to display a keyboard and press a key of the displayed keyboard due to the limit of a display. Therefore, the input of a PIN, which includes only numbers, is preferred to the input of a password including other characters.

However, because a PIN, which is simply a combination of numbers, is difficult to memorize, security codes, each of which has a smaller number of digits than the number of digits of a password, are set. Therefore, the set security codes increases the risk of exposure.

In the pattern input scheme which has recently being used, a security code is set by a combination according to the arrangement and the order of a preset number of nodes. The set security code depends on the memory of a user, and simple codes are selected for the convenience of lifting the setting of the security code by a user. Therefore, the pattern input scheme is not considered to have a good security property in that the set security code may be easily shown to other people around the user.

Because the schemes are touch-based ones and depend on the memories of users, recently, due to the development of a biometric technology, methods for equipping a portable device with technologies for recognizing the face, fingerprints, and the like, of users are being studied. Although biometrics has an advantage in that it does not depend on the convenience and the memory of a user, it has disadvantages in that it has many variables related to an environmental change and thus has a reduced accuracy. Particularly, the recognition of fingerprints has a disadvantage in that it needs a dedicated sensor such as an Infrared Ray (IR) sensor.

### SUMMARY OF THE INVENTION

Accordingly, an aspect of the present invention is to solve the above-mentioned problems, and to provide an apparatus and a method for security, by which security authentication can be conveniently performed by using the recognition of the face of a user in various environments.

In accordance with an aspect of the present invention, a security apparatus using face authentication is provided. The apparatus includes a face detector for detecting a facial region in an input image; a face guide region generator for generating a face guide region for authenticating a face in the input image, and displaying the generated face guide region on a screen; an image capturer for capturing the input image when the detected facial region is matched with the face guide region; a facial feature extractor for extracting information regarding features of the face from the captured input image; and a facial feature storage unit for storing the extracted information regarding the features of the face.facial region facial region regarding the features of the face

In accordance with another aspect of the present invention, a method for security using face authentication is provided. The method includes detecting a facial region from an input image;

generating a face guide region for authenticating a face in the input image, and displaying the generated face guide region on a screen; capturing the input image when the detected facial region is matched with the face guide region; extracting information regarding features of the face from the captured input image; and storing the extracted information regarding the features of the face.

### BRIEF DESCRIPTION OF THE DRAWINGS

The above and other aspects, objects, features, and advantages of the present invention will be more apparent from the following detailed description taken in conjunction with the accompanying drawings, in which:

FIG. 1 is a block diagram illustrating the configuration of a security management apparatus according to an embodiment of the present invention;

FIG. 2 illustrates the right image having a low luminance and the left image having backlight according to an embodiment of the present invention;

FIG. 3 illustrates three different face guide regions according to an embodiment of the present invention;

FIG. 4 illustrates an operation for identifying whether a user wears something on his/her face according to an embodiment of the present invention;

FIG. 5 and FIG. 6 illustrate a method for performing registration of a face for security authentication according to an embodiment of the present invention; and

FIG. 7 is a flowchart illustrating a method for performing face authentication for security authentication according to an embodiment of the present invention.

### DETAILED DESCRIPTION OF EMBODIMENTS OF THE PRESENT INVENTION

Hereinafter, embodiments of the present invention will be described in detail with reference to the accompanying drawings. In the following description and the accompanying drawings, a detailed description of known functions and configurations that may unnecessarily obscure the subject matter of the present invention will be omitted.

The present invention provides an apparatus and a method for managing the security of a portable terminal using face recognition technology.

In order to authenticate a face, embodiments of the present invention include a configuration for extracting and registering information regarding features of the face of a user by a terminal with a built-in front-facing camera; and a configuration for extracting information regarding features of a face from a face image obtained by the front-facing camera, which automatically operates when security authentication is required, and comparing the registered information regarding features of a face with the extracted information regarding features of a face by the terminal with the built-in front-facing camera.

In order to set security and utilize the set security in a portable terminal, a process of registering and authenticating a face is performed, and a series of processes for recognizing a face, which include a process of driving a camera, a process of capturing a face, a process of extracting features of a face, etc., is performed. Embodiments of the present invention include a scenario for improving the performance of authenticating a face in each process.

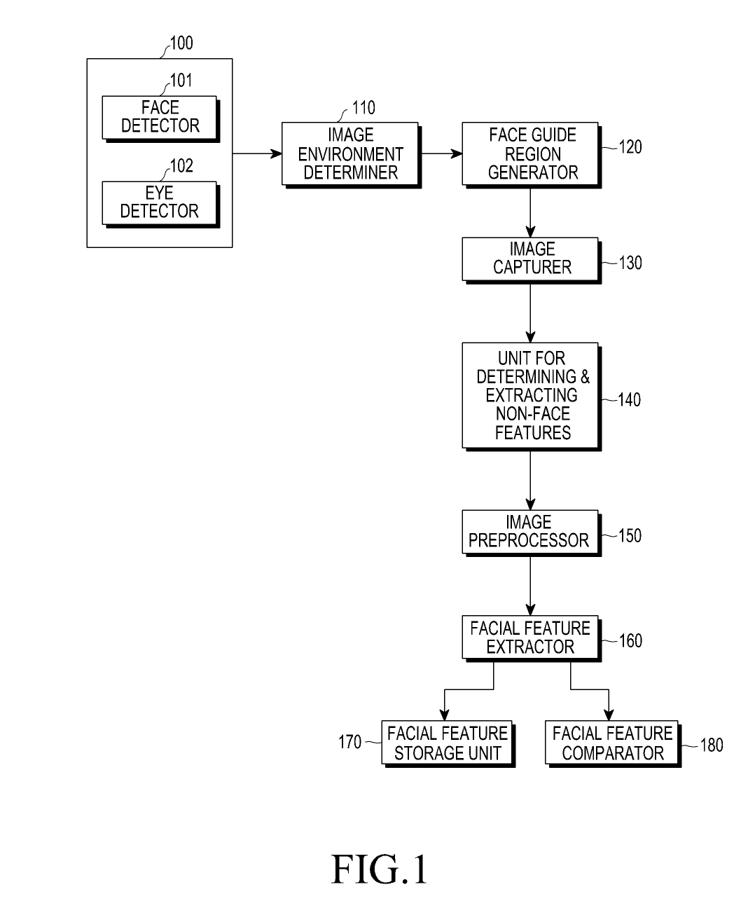

FIG. 1 is a block diagram illustrating the configuration of a security management apparatus according to an embodiment of the present invention.

A security management apparatus according to the present invention includes a detection unit 100, which includes a face detector 101 and an eye detector 102, an image environment determiner 110, a face guide region generator 120, an image capturer 130, a unit for determining and extracting non-face features 140, an image preprocessor 150, a facial feature extractor 160, a facial feature storage unit 170, and a facial feature comparator 180.

When a request has been made for setting security of a terminal through the face authentication and an image, which has been input from a camera, the image is displayed on a preview screen of the camera, and the detection unit 100 detects a face and eyes.

Specifically, the face detector 101 searches for a position of the face in the input image, and detects the position of the face as a facial region.

The eye detector 102 searches for coordinates of the left eye and the right eye within the detected facial region, and detects the found coordinates of the left eye and the right eye as the positions of the eyes.

The image environment determiner 110 determines whether an environment for capturing an image of a user (e.g., a lighting environment of the user) corresponds to preset conditions of an environment for capturing an image. Specifically, when an image of the face of the user is captured in order to authenticate a face in an environmental condition of poor lighting (e.g., a low luminance or backlight), it is difficult to detect the face. Although the face is detected, it is difficult to ensure the performance of detecting both eyes, and thus it is difficult to rely on a result of the authentication.

In this case, the image environment determiner 110 of the present invention determines whether the input image has a low luminance or backlight. When a result of the determination shows that the input image has a low luminance or backlight, the image environment determiner 110 provides another security authentication scheme (e.g., a method for inputting a password or a method for inputting a PIN).

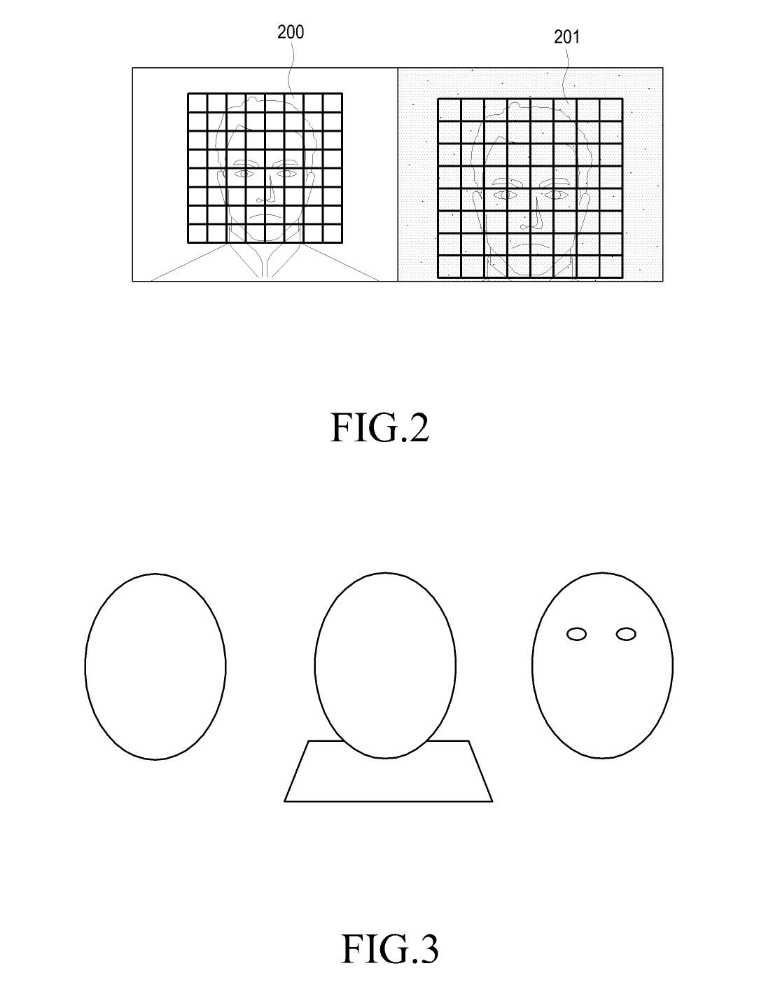

FIG. 2 illustrates the right image having a low luminance and the left image having a backlight according to an embodiment of the present invention.

The image environment determiner 110 detects a facial region, which has been detected with a preset number of blocks as a unit as designated by reference numeral 200 or 201 in FIG. 2, and brightness values around the facial region, and generates a brightness histogram of 8 levels by using the extracted brightness values.

When the brightness histogram has brightness values concentrated in a lower part thereof and an inner part of the face has a low brightness value, the image environment determiner 110 determines that an image has a low luminance. Otherwise, when a light saturation phenomenon appears around a facial region and a shade phenomenon exists within the facial region due to the light saturation phenomenon, the image environment determiner 110 determines that the image has backlight. By using a histogram, which is used to determine whether an image has a low luminance, when a brightness value of the brightness histogram and a brightness value of an inner part of the face is smaller than a preset threshold, an image is determined to be an image having a low luminance. When a brightness value of a facial region is smaller than a preset threshold, the image may be determined to be an image having backlight.

In the present invention, when conditions of an environment for capturing an image are satisfied, the image capturer 130 captures an input image. However, when the conditions of an environment for capturing an image are not satisfied, the inputting of the security of another terminal is provided instead of the face authentication.

The face guide region generator 120 displays a face guide region of a predetermined size and a guide region of both eyes, which are applied to all faces, on a preview screen based on the detected coordinates of both eyes.

Specifically, when a user has made a request for registering the face of the user, a front camera for self-capture operates, and the detection unit 100 detects, in real time, a position of a facial region and coordinates of the eyes from a preview image of the user which is input through the front camera for self-capture. Thereafter, the face guide region generator 120 predicts a distance between the user and the camera and an optimized position of a guide and generates a face guide region, based on the detected size and position of the facial region, the detected distance between both eyes and the detected positions of both eyes, and then displays the generated face guide region on a preview screen.

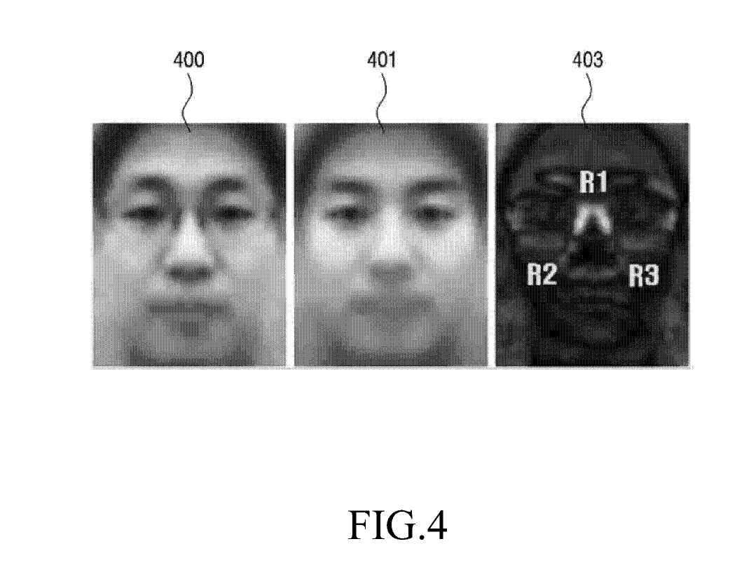

FIG. 3 illustrates three different face guide regions according to an embodiment of the present invention.

In order to ensure the representativeness of information regarding features of a face, which is to be registered, the face guide region generator 120 displays a face guide region as illustrated in FIG. 3 on a preview screen, and determines whether there is information having features coinciding with the size and position of the facial region, the distance between both eyes, and the positions of both eyes within the displayed face guide region. The face guide region generator 120 then displays a result message on a preview screen according to a result of the determination.

The image capturer 130 captures an input image displayed on the preview screen. The image capturer 130 analyzes the continuity of image frames for a preset time period, and automatically or manually captures an input image when a value of the analyzed continuity is greater than or equal to a threshold. When an image is manually captured, the image capturer 130 induces a user to directly capture an image by outputting a dynamic signal or by displaying an image capture message on a screen.

Such an operation is defined as the normalization of the position of a face. The faces normalized as described above all have an identical size of an image, and have identical positions of the eyes in the image. Therefore, it is possible to prevent the reduction of a recognition rate caused by a rotation or a change in the size of a face.

When the image of the face has been captured, the image capturer 130 provides information including the positions of the eyes, whether the eyes are blinked, hand tremor information, etc., so as to induce a user to identify whether there is a problem in image quality of the captured image as a representative image. When the user does not agree to the use of the captured image as a representative image, the camera may operate again, and then may capture an image of the user again.

Moreover, in a step of security authentication, in order to predict in what external environment (e.g., in what lighting environment) an authentication requester makes the request for authentication, and thus multiple images may further be generated by performing changing the lighting conditions and pose on one image captured by an image capturer 130.

For example, the image capturer 130 generates an image which appears to be captured in a virtual lighting environment in such a manner as to first capture an image and then model various lighting changes. Otherwise, the image capturer 130 generates, from the captured image, images whose poses are changed using warping technologies considering pose change.

The unit for determining and extracting non-face features 140 first determines information regarding non-face features, which includes gender, age, race and whether the subject is wearing glasses, as well as the shape or texture of a face, and then extracts information regarding non-face features. Information regarding non-face features, which has been extracted as described above, is first combined with information regarding features of a face, and then the combined information is used to digitize features of a user.

Both information regarding features of a face, which has been extracted from the input image, and also information regarding non-face features (e.g. gender, whether glasses are worn, or the like) are used to represent the unique characteristics of the user. When the result obtained according to the scheme as described above shows, for example, that if the gender and whether glasses are worn of an authentication requester do not coincide with the registered information, the comparison of the face of the user with the registered information, a large number of “points” are subtracted.

In order to analyze gender, the unit for determining and extracting non-face features 140 collects male face data and female face data, and then may distinguish between male and female through learning using a classifier capable of discriminating between male face data and female face data.

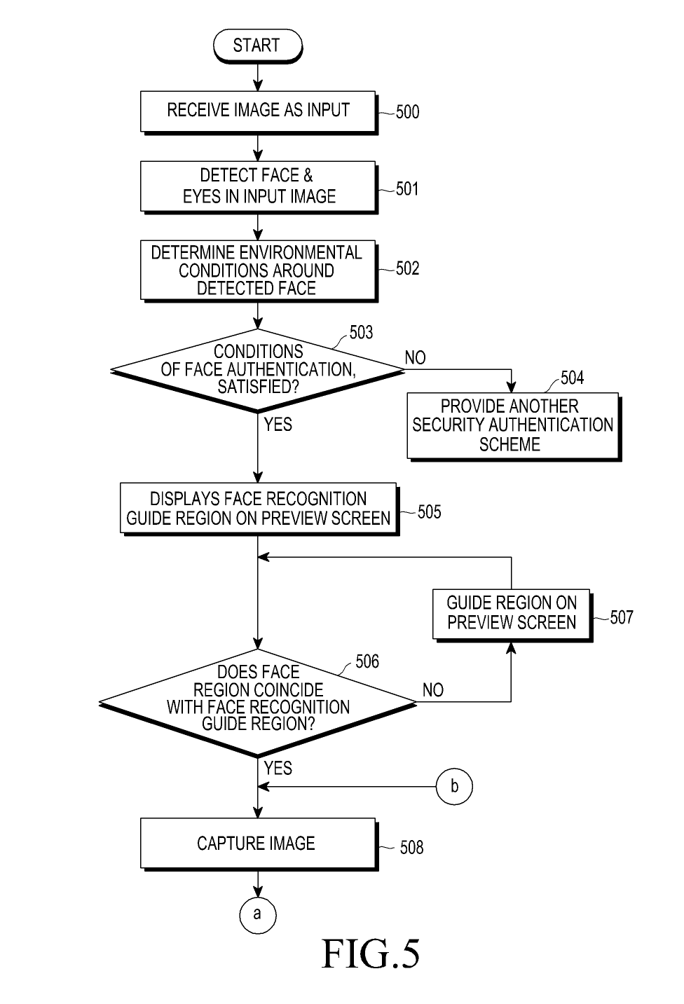

FIG. 4 illustrates an operation for identifying whether a user is wearing something on his face.

In order to identify whether glasses are worn, the unit for determining and extracting non-face features 140 first collects data on faces, each of which wears glasses, as designated by reference numeral 400 in FIG. 4 and data of faces, where the user does not wear glasses, as designated by reference numeral 401, calculates an average of faces with glasses and an average of faces without glasses, and then analyzes a difference between the average of the faces with glasses and the average of the faces without glasses. The unit for determining and extracting non-face features 140 selects R1, R2 and R3, as designated by reference numeral 403, which are regions where glasses are predicted to be located on the face, and whether the glasses are worn is determined by analyzing the distribution of edges within the selected regions.

The image preprocessor 150 performs preprocessing for minimizing external factors (e.g., lighting) effecting the texture of the face in the image of the face.

The facial feature extractor 160 extracts multiple pieces of information regarding features of the face from the image of the face on which preprocessing has been completed. Specifically, the facial feature extractor 160 extracts the multiple pieces of information regarding the features of the face from multiple images generated by performing lighting changes and pose changes on one image captured by the image capturer 130.

The facial feature storage unit 170 stores the multiple pieces of extracted information regarding the features of the face.

The facial feature storage unit 170 stores information regarding features of the user, including the information regarding non-face features, which has been extracted by the unit for determining and extracting non-face features 140, and the multiple pieces of extracted information regarding the features of the face.

When the user has made a request for face authentication for security authentication, the detection unit 100, the image environment determiner 110, the face guide region generator 120, the image capturer 130, the unit for determining and extracting non-face features 140, the image preprocessor 150, and the facial feature extractor 160 perform operations similar to those in the process of registering a face, respectively.

Particularly, the image capturer 130 simultaneously acquires multiple pieces of information on consecutive image frames while capturing the face of the user, as described above.

The facial feature extractor 160 extracts information regarding features of a face, which corresponds to each of the multiple consecutive image frames from the multiple pieces of the acquired information on the consecutive image frames.

When a request has been made for security authentication, the facial feature comparator 180 compares, with multiple pieces of information regarding features of users which are stored in the facial feature storage unit 170, multiple pieces of information regarding features of the user including both the multiple pieces of information regarding the features of the face, which have been extracted by the facial feature extractor 160 in order to authenticate a face, and the information regarding non-face features, which has been extracted by the unit for determining and extracting non-face features 140.

Namely, similarity values of the multiple pieces of information on the features of the user which have been extracted for authentication are compared to similarity values of multiple pieces of stored information regarding features of users. When a result of the comparison shows that a similarity value between the extracted information on the features of the user and stored information regarding features of a user is equal to or larger than a preset threshold, the facial feature comparator 180 outputs a value indicating access is allowed. However, when the result of the comparison shows that a similarity value between the extracted information on the features of the user and stored information regarding features of a user is smaller than the preset threshold, the facial feature comparator 180 outputs a value resulting from refusing the cancellation of security, so as to maintain security.

As described above, the multiple pieces of extracted information regarding the features of the user are compared with multiple pieces of stored information regarding features of users, so that the reliability of the results of the authentication is more accurate. For example, when the number of multiple pieces of registered information regarding features of a face is “3,” and that of multiple pieces of acquired information regarding features of a face is “2,” a comparison is made between multiple pieces of face information, the total number of which is 6 pairs. Therefore, in this case, more reliable results of authentication are output than in a case in which one piece of acquired information regarding features of a face is compared with one piece of registered information regarding features of a face.

In the present invention, when the face of the user is captured, it is necessary to prevent the forgery of photographs. Therefore, in a step of capturing a face, facial gestures, which include a smiling expression, a surprised expression, a happy expression, a sad expression, a perplexed expression, a blink of the eyes, a wink, and the like, on the face of the user, are set for the user. As described above, the user sets a facial gesture as a personal secret, and the registered facial gesture is identified during the face authentication, so that it is possible to prevent the forgery of photographs.

Also, in the present invention, because many changes occur in the appearance, the style or the like of a user as time passes, the facial feature storage unit 170 may update all or part of multiple pieces of stored information regarding features of faces to several pieces of information regarding features of faces, which have recently been successfully authenticated. A threshold under conditions of the replacement of face information as described above has a larger value than a threshold under conditions of authentication success.

Specifically, in order to continuously update information regarding features of a user, which reflects a recent change in the appearance or the style of the user, a replacement threshold used to replace information regarding features of a user is set to a value larger than that of a comparison threshold which has been preset for the determination of similarity.

Accordingly, when the result of the comparison shows that a similarity value between the extracted information on the features of the user and stored information regarding features of a user is equal to or larger than a replacement threshold, the facial feature storage unit 170 not only determines the authentication to be successful, but also replaces at least one of multiple pieces of stored information regarding features of users by the extracted information on the features of the user, having a similarity value between itself and stored information regarding features of a user which is equal to or larger than the replacement threshold. Then, the facial feature storage unit 170 stores the replaced information on the features of the user.

Accordingly, in the present invention, a recent appearance of a user is periodically updated, so that it is possible to achieve a higher recognition rate.

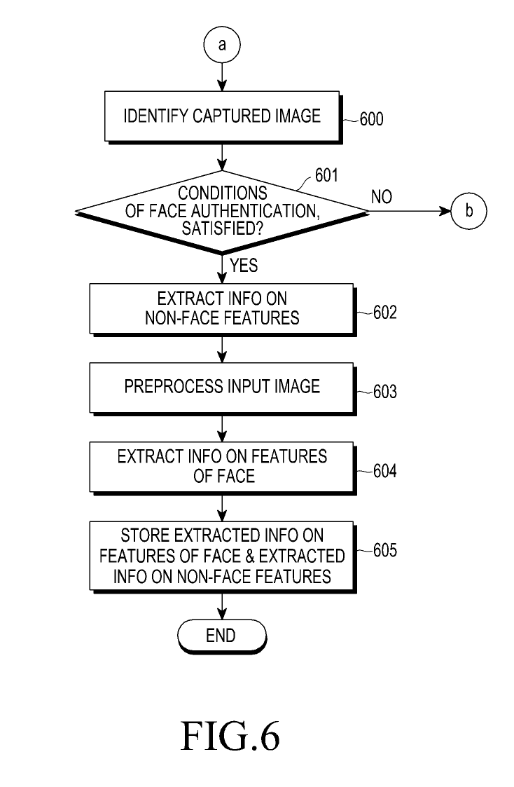

FIG. 5 and FIG. 6 are flowcharts illustrating a method for performing the registration of a face for security authentication according to an embodiment of the present invention.

When an image has been input from the camera in step 500, the detection unit 100 detects a face and eyes in step 501. Specifically, the face detector 101 searches for a position of the face in the input image, and detects the found position of the face as a facial region. The eye detector 102 searches for coordinates of the left eye and the right eye within the detected facial region, and detects the found coordinates of the left eye and the right eye as positions of both eyes.

In step 502, the image environment determiner 110 determines whether an environment for capturing an image of a user (e.g. a lighting environment of the user) around the extracted facial region corresponds to preset conditions of an environment for capturing an image.

In step 503, the image environment determiner 110 determines whether the input image satisfies conditions of face authentication. When a result of the determination shows that the input image satisfies the conditions of face authentication, the process proceeds to step 505. On the other hand, when the result of the determination shows that the input image does not satisfy the conditions of face authentication, the process proceeds to step 504 where another security authentication scheme is provided by the image environment determiner 110.

In other words, the image environment determiner 110 of the present invention determines whether the input image has a low luminance or backlight. When a result of the determination shows that the input image has a low luminance or backlight, the image environment determiner 110 provides another security authentication scheme.

In step 505, the face guide region generator 120 displays a face guide region of a preset size and a guide region of both eyes, which are to be identically applied to all faces, on a preview screen based on the detected facial region and the detected coordinates of both eyes.

In step 506, the face guide region generator 120 determines whether information on the detected position of the face and the detected positions of the eyes coincides with information on the position of the facial region and the positions of the eyes (e.g. the size and position of the facial region, the distance between both eyes, and the positions of both eyes) within the displayed face guide region. When a result of the determination shows that information on the detected position of the face and the detected positions of the eyes coincides with information on the position of the facial region and the positions of the eyes, the process proceeds to step 508. However, when the result of the determination shows that information on the detected position of the face and the detected positions of the eyes does not coincide with information on the position of the facial region and the positions of the eyes, the process proceeds to step 507 where a guide message indicating that the former information does not coincide with the latter information, is displayed on the preview screen.

In step 508, the image capturer 130 captures an input image displayed on the preview screen. The image capturer 130 analyzes the continuity of image frames for a preset time period, and automatically or manually captures an input image when a value of the analyzed continuity is equal to or larger than a preset threshold.

When the process proceeds from step 508 to step \textcircled{a}, steps after step \textcircled{a} will be described with reference to FIG. 6.

When proceeding from step \textcircled{a} to step 600 causes the image of the face to be captured, in step 601, the image capturer 130 determines whether the input image of the face satisfies conditions of face authentication, which include the positions of the eyes, whether the eyes are closed or are blinking, hand tremor information, and the like. When the result of the determination shows that the input image of the face satisfies the conditions of face authentication, the process proceeds to step 602. However, when the result of the determination shows that the input image of the face does not satisfy the conditions of face authentication, the process proceeds from step \textcircled{b} shown in FIG. 5 to step 508, and in step 508, an image is captured again.

In step 602, the unit for determining and extracting non-face features 140 first determines information regarding non-face features, which includes gender, age, race and whether glasses are worn, as well as the shape or texture of a face itself, and then extracts information regarding non-face features.

The information regarding non-face features, which has been extracted as described above, is first combined with information regarding features of a face, and then the combined information may be used to digitize features of a user.

In step 603, the image preprocessor 150 performs preprocessing for minimizing external factors (e.g., lighting) affecting the texture of the face in the image of the face.

In step 604, the facial feature extractor 160 extracts multiple pieces of information regarding features of the face from the image of the face on which preprocessing has been completed.

In step 605, the facial feature storage unit 170 stores the information regarding non-face features, which has been extracted by the unit for determining and extracting non-face features 140, together with the multiple pieces of extracted information regarding the features of the face.

As described above, in the present invention, a security apparatus, which uses the face authentication scheme in various environments, can be commercialized. Therefore, the user can conveniently set and/or cancel security by using a captured face without the need for separately inputting a password and/or a PIN.

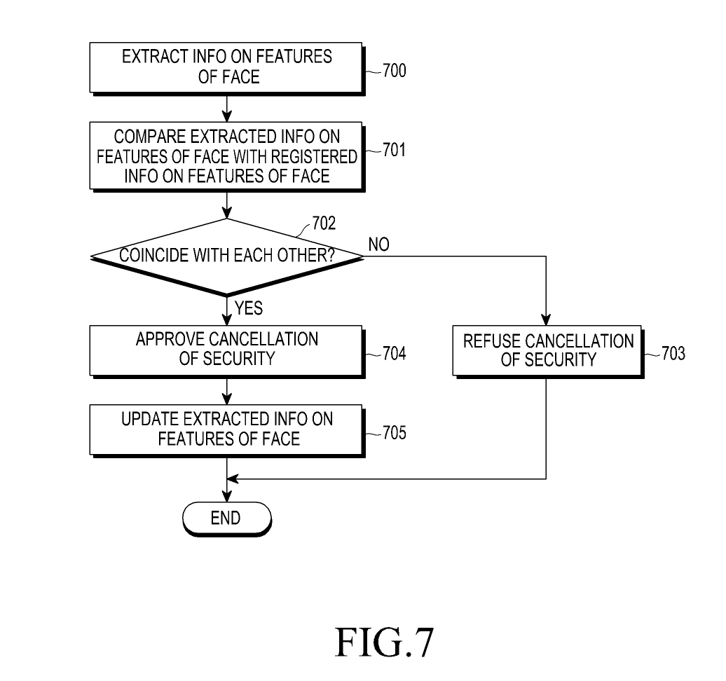

FIG. 7 is a flowchart illustrating a method for performing the face authentication for security authentication according to an embodiment of the present invention.

In an embodiment of the present invention, after performing the process similar to steps 500 to 507 shown in FIG. 5 and steps 600 to 603 shown in FIG. 6, step 700 shown in FIG. 7 is performed.

In step 700, the facial feature extractor 160 extracts multiple pieces of information regarding features of a user from the image captured by the image capturer 130.

In step 701, the facial feature comparator 180 compares multiple pieces of information regarding features of the user with multiple pieces of stored information regarding features of users.

In step 702, the facial feature comparator 180 determines, based on a result of the comparison, whether multiple pieces of information regarding features of the user coincide with multiple pieces of stored information regarding features of users. When a result of the determination shows that multiple pieces of information regarding features of the user coincide with multiple pieces of stored information regarding features of users, the process proceeds to step 704 where the approval of cancellation of security is output as the result of the comparison. However, when the result of the determination shows that multiple pieces of information regarding features of the user do not coincide with multiple pieces of stored information regarding features of users, the process proceeds to step 703 where the refusal of cancellation of security is output as the result of the comparison.

In step 705, the facial feature storage unit 170 updates all or part of multiple pieces of stored information regarding features of faces to several pieces of information regarding features of faces, which have recently been successfully authenticated.

Although the above description has been made of an example where information regarding features of a face is updated, information regarding features of a face may be updated together with information regarding non-face features.

As described above, in the present invention, a security apparatus, which uses the face authentication scheme in various environments, may be commercialized. Therefore, the user can conveniently set and/or cancel security by using a captured face without the need for separately inputting a password and/or a PIN.

According to the present invention, images of a face which reflect various environments are registered, a captured image is compared with the registered images during security authentication, and security is maintained or cancelled based on a result of the comparison, so that a security apparatus, which uses the face authentication scheme in various environments, can be commercialized. Therefore, the user can conveniently set and/or cancel security by using a captured face image without the need for separately inputting a password and/or a PIN.

Although embodiments have been shown and described in the description of the present invention as described above, various changes in form and details may be made in the specific embodiments of the present invention without departing from the spirit and scope of the present invention. Therefore, the spirit and scope of the present invention is not limited to the described embodiments thereof, but is defined by the appended claims and their equivalents.

What is claimed is:

1. A security apparatus using face authentication, the apparatus comprising:
a face detector for detecting a facial region in an input image;
a face guide region generator for generating a face guide region for authenticating a face in the input image, and displaying the generated face guide region on a screen;
an image capturer for capturing the input image when the detected facial region is matched with the face guide region;
a facial feature extractor for extracting information regarding features of the face from the captured input image; and
a facial feature storage unit for storing the extracted information regarding the features of the face.

2. The apparatus of claim 1, further comprising:
an image environment determiner for determining whether an external environment around the facial region satisfies preset environmental conditions in order to authenticate the face,
wherein the image environment determiner provides another security authentication scheme when the external environment around the facial region fails to satisfy the preset environmental conditions.

3. The apparatus of claim 1, further comprising:
a unit for determining and extracting non-face features for extracting information regarding non-face features including information on gender, age and race of a user, and whether the user wears glasses, and
wherein the facial feature storage unit stores information regarding features of the user including the extracted information on the non-face features and the extracted information regarding the features of the face.

4. The apparatus of claim 1, further comprising:
an image preprocessor for performing preprocessing for minimizing external factors affecting texture of the facial region.

5. The apparatus of claim 1, wherein the image capturer identifies positions of eyes, whether the eyes are closed or blinking, and hand tremor information in the captured input image and determines whether the captured input image is suitable as a registration image, and outputs re-capturing of an image as a result of the determination when the result of the determination is that the captured input image is not suitable as the registration image.

6. The apparatus of claim 1, wherein the image capturer generates multiple registration images by applying various lighting changes and various pose changes to the captured input image, the facial feature extractor extracts multiple pieces of information regarding features of the face from the multiple registration images, and the facial feature storage unit stores the multiple pieces of extracted information regarding the features of the face.

7. The apparatus of claim 6, wherein the image capturer captures the input images and acquires multiple pieces of information on consecutive image frames in the captured input images, when a request has been made for the authentication of the face for security authentication.

8. The apparatus of claim 7, wherein the facial feature extractor extracts multiple pieces of facial feature comparison information from the captured input images and the multiple pieces of information on the consecutive image frames.

9. The apparatus of claim 8, further comprising:
a facial feature comparator for comparing the multiple pieces of facial feature comparison information with multiple pieces of facial feature registration information stored in the facial feature storage unit,
wherein the facial feature comparator calculates a similarity value between the multiple pieces of facial feature comparison information and the multiple pieces of facial feature registration information, outputs a result of the comparison indicating approval of cancellation of security when the calculated similarity value is greater than or equal to a preset threshold, and outputs the result of the comparison indicating that security is activated when the calculated similarity value is less than the preset threshold.

10. A method for security using face authentication, the method comprising:
detecting a facial region from an input image;
generating a face guide region for authenticating a face in the input image, and displaying the generated face guide region on a screen;
capturing the input image when the detected facial region is matched with the face guide region;
extracting information regarding features of the face from the captured input image; and
storing the extracted information regarding the features of the face.

11. The method of claim 10, further comprising:
determining whether an external environment around the facial region satisfies preset environmental conditions in order to authenticate the face; and
providing another security authentication scheme when the external environment around the facial region fails to satisfy the preset environmental conditions.

12. The method of claim 10, further comprising:
extracting information regarding non-face features including information on gender, age and race of a user, and whether the user wears glasses; and
storing information regarding features of the user including the extracted information on the non-face features and the extracted information regarding the features of the face.

13. The method of claim 10, further comprising:
performing preprocessing for minimizing external factors effecting texture of the facial region.

14. The method of claim 10, further comprising:
identifying positions of eyes, whether the eyes are closed or blinking, and hand tremor information in the captured input image and determining whether the captured input image is suitable as a registration image; and
re-capturing an image when a result of the determination shows that the captured input image fails to be suitable as the registration image.

15. The method of claim 10, further comprising:
generating multiple registration images by applying various lighting changes and various pose changes to the captured input image;
extracting multiple pieces of facial feature registration information from the multiple registration images; and
storing the multiple pieces of extracted facial feature registration information.

16. The method of claim 15, further comprising:
when a request has been made for the authentication of the face for security authentication, capturing the input images; and
acquiring multiple pieces of information on consecutive image frames in the captured input images.

17. The method of claim 16, further comprising:
extracting multiple pieces of facial feature comparison information from the captured input images and the multiple pieces of information on the consecutive image frames.

18. The method of claim 17, further comprising:
comparing the multiple pieces of facial feature comparison information with the multiple pieces of stored facial feature registration information;
calculating a similarity value between the multiple pieces of facial feature comparison information and the multiple pieces of facial feature registration information;
approving a cancellation of security when the calculated similarity value is greater than or equal to a preset threshold; and
keeping security activated when the calculated similarity value is less than the preset threshold.
